(19) United States
(12) Patent Application Publication
(10) Pub. No.: US 2011/0267220 A1
(43) Pub. Date: Nov. 3, 2011

(54) SENSOR NODE POSITIONING IN A SENSOR NETWORK

(76) Inventors: John Paul Strachan, Millbrae, CA (US); R. Stanley Williams, Portola Valley, CA (US)

(21) Appl. No.: 12/772,115

(22) Filed: Apr. 30, 2010

(51) Int. Cl. G01S 13/42

(52) U.S. Cl. 342/126; 342/146; 342/133

(57) ABSTRACT

Systems and methods for positioning sensor nodes in a sensor network are described. A system can include multiple base nodes. The base nodes can have a differential global positioning system. The global positioning system can be used to determine a precise location of the base nodes. Sensor nodes can be placed in locations with respect to the plurality of base nodes using measurement data from at least one of the base nodes. A positional device can provide the position measurement data relative to the base nodes to a user for use in placing the plurality of sensor nodes. A communications system enables electronic communication between the base nodes and the sensor nodes.

### BACKGROUND

A sensor network can include spatially distributed, networked sensors useful for monitoring an area. For example, the sensors may be used to monitor physical or environmental conditions, such as temperature, sound, vibration, pressure, motion or pollutants. Sensor networks are used in many industrial, military, and civilian applications. For example, sensor networks can be useful in monitoring or controlling industrial processes, machine health, environment, building structures, healthcare, home automation, traffic control, and so forth.

Sensors in sensor networks can be nodes in the network. In the case of wireless sensor networks, each node may be equipped with a radio transceiver or other wireless communication device, a small microcontroller, and an energy source (such as a battery, for example). Sensors can be created in a variety of sizes, costs, or functionality, and the sensor variations can be a function of the purpose for which the sensor network is being implemented. For example, different sensor network uses may involve different resource usages in terms of energy, memory, computational speed, and bandwidth.

Previous systems for placing sensors or identifying a precise location of sensors in a sensor network have a number of drawbacks. Prior systems can be time-consuming and expensive to implement, or may be harmful to the environment. For example, some systems use heavy machinery to perform surveys, setup a cable grid over the landscape, plant flags identifying locations to place sensor devices, etc. Use of heavy machinery can be damaging to the environment. Furthermore, where the sensor network is established over rugged terrain, the area for the sensor network may be inaccessible by machine. Systems involving hand-planting of flags as part of a survey to identify sensor device locations, or simply having workers approximate the appropriate sensor location can result in sensors not being precisely located. For some sensor applications, greater precision is desired than may be achieved using such a system. Other systems have used Global Positioning System (GPS) devices to precisely determine locations for sensor devices. However, GPS systems can also be expensive and result in large time expenditures while waiting for an update of the precise location of the worker and then determining where the worker's location is with respect to the location where the sensor is to be placed.

### BRIEF DESCRIPTION OF THE DRAWINGS

FIG. 1 is a block diagram of a sensor network in accordance with an example of the present disclosure;

FIG. 2 is a block diagram of a base node used in a system for positioning sensor nodes in a sensor network in accordance with an example of the present disclosure;

FIG. 3 is a side view of a sensor device with an attached reflector, in accordance with an example of the present disclosure; and

FIGS. 4-5 are flow diagrams of methods for placing sensor devices in a sensor network in accordance with examples of the present disclosure.

### DETAILED DESCRIPTION

Reference will now be made to the exemplary embodiments illustrated, and specific language will be used herein to describe the same. It will nevertheless be understood that no limitation of the scope of the technology is thereby intended. Additional features and advantages of the technology will be apparent from the detailed description which follows, taken in conjunction with the accompanying drawings, which together illustrate, by way of example, features of the technology.

As used herein, the term “field” refers to an area in which one or more components of a sensor network are placed. A field can be indoor or outdoor. The field can be an urban area, a metropolitan area, a wilderness area, an agricultural area, or any other type of area in which a sensor network may be used. The field may even include an underwater area, such as may be used in an undersea sensor network. The field may include the space around a radiating light source within which electromagnetic oscillations of the source can extend and be reflected from another body not in contact with the source.

Previous systems and methods for placing sensors have been time consuming, damaging to the environment, and/or inaccurate in precise placement of the sensors. Other systems have been developed to determine a sensor device location after the device is placed. In other words, the precise location of the sensor device is not known until after placement and after use of GPS, cellular signals, etc. The systems and methods for positioning sensor nodes in a sensor network as described herein overcome previous deficiencies by enabling precise placement of sensor nodes at predetermined locations rapidly, less expensively, and without damaging the environment.

Systems and methods for positioning sensor nodes in a sensor network are described. A system can include multiple base nodes. The base nodes can have a differential global positioning system. Sensor nodes can be placed in locations with respect to the plurality of base nodes using measurement data from one or more base nodes. A positional device can provide the position measurement data relative to the base nodes to a user for use in placing the plurality of sensor nodes. A communications system enables electronic communication between the base nodes and the sensor nodes. Although the systems and methods described herein may include post-placement determination of sensor node locations, this determination may simply provide a refinement of the known sensor node location since the systems and methods provide for placement in the specific location rather than determination of location after placement.

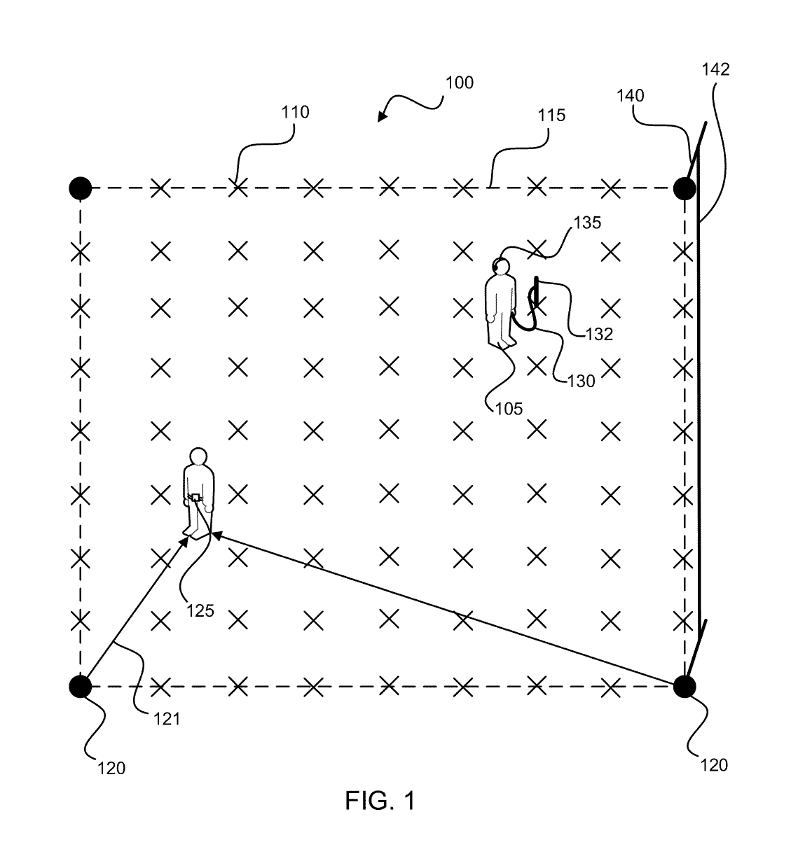

Referring to FIG. 1, a system 100 is shown which is configured for use in placing sensor devices in a field. The system can include multiple base nodes 120. FIG. 1 depicts four base nodes defining corners of a field or corners of a grid 115 for sensor devices. However, the system may include any number of base nodes and the base nodes need not be placed at corners or in any regular pattern. Further, though the grid for sensor devices is shown having a regular shape and pattern, the grid can alternatively comprise an irregular shape and/or pattern. Each of the base nodes can include a differential global positioning system (GPS). The differential GPS can enable determination of a precise location of the base nodes. The base nodes with the differential GPS can act as reference points with high quality positional data for positioning sensor nodes. (Differential GPS is an enhancement to GPS that uses a network of fixed, ground-based reference stations to broadcast the difference between the positions indicated by the satellite systems and the known fixed positions).

The system can include sensor nodes configured to be placed in locations 110 (represented by an ‘X’ in the figure) with respect to the plurality of base nodes using measurement data from at least one or two of the plurality of base nodes. The locations for placement can be predetermined locations. In this example, only the base nodes include the differential GPS rather than all of the sensor nodes to be placed in the field. This can reduce cost and complexity of the system. Where a large number of sensor nodes are to be placed in a field, waiting for integration times (retrieval of the GPS position) typical of differential GPSes on all sensor nodes can be a time-consuming and costly endeavor. Many differential GPSes have integration times of greater than one minute. Without inclusion of a differential GPS, the sensor nodes can be passive, low cost and low power nodes. In one example, the sensor nodes may comprise approximately 99% of the nodes of the system. The other approximately 1% can be the base nodes.

The system includes a positional device. The positional device can provide the position measurement data relative to the base nodes to a user for use in placing the sensor nodes. Use of the positional device with the base nodes and the sensor nodes can enable installation of a high number of sensors, such as 1,000,000 or more, within a few centimeters accuracy and with a rapid installation time. For example, the system can be used to deploy as many as 100,000 nodes in a sensor network per day. Because the base nodes provide reference points with high quality positional data, accurate relative positions for the sensor nodes can be quickly and easily determined using the positional device.

The positional device may take a variety of forms. For example, the positional device may include a triangulation module for triangulation of laser signals, cellular signals, radio signals, etc. in determining a position of a sensor node for placement. In another example, the positional device may include a laser radar system. In another example, the positional device may include a transmitted Radio Frequency (RF), acoustic, or optical signal which serves as a beacon in placing the sensor nodes. In this RF example, a time or phase delay can be used to determine a distance from the base node to the sensor device.

In another example, the positional device can include a phase lock loop interferometry module. The phase lock loop interferometry module can provide an array of sound or electromagnetic waves over at least a portion of the field extending between at least two of the base nodes. The array can include wave peaks caused by interferometry. The sensor nodes can be placed at the wave peaks. In a further example, sensor nodes can be attached to or associated with a cable. The cable can be stretched out on the ground in alignment with base nodes or parallel or perpendicular to a line extending between base nodes. Additional ropes or cables can extend between base nodes to provide a more visible reference to use as a basis for the parallel or perpendicular orientation of the cable with the sensor nodes. The positional device may also comprise any combination of the example devices above. Furthermore, the examples of positional devices described above do not comprise an exhaustive list of the devices contemplated and other positional devices may also be used.

Still referring to FIG. 1, some examples of positional devices are shown. A user 105 can wear or hold a retroreflector 125 from which rotating optical beams of light 121 (infrared, near infrared, visible, ultraviolet, etc.) are reflected back to detectors at the base nodes 120. Because the precise location of the base nodes is known, an angle of rotation of the rotating optical beams at the time a reflection is detected can be used from two (or more) base nodes to triangulate a position of the retroreflector. A guidance module, which will be discussed in further detail below, can then guide the worker based on the triangulated position.

Another example positional device is shown in FIG. 1 in which a line 142, such as a cable or a rope or the like, is extended between posts 140 erected at two of the base nodes. The worker 105 can use a cable 130 having a predetermined length to determine a distance from a placed sensor node to the placement position for a subsequent sensor node. The line can provide a reference for alignment of the cable, such as for alignment of the cable parallel to the line. The cable can be attached to a stake 132 temporarily placed in the ground to hold one end in position.

The system can include a communications system. The communications system can enable electronic communication between the base nodes and the plurality of sensor nodes. In one example, each of the sensor nodes can include a unique identifier. The sensor nodes can record events, including a time stamp of a date and time of the event. Because the location of placed sensor nodes is known precisely, useful information can be obtained about events, including the precise location and time of the events.

The communications system can also enable post-placement position determination of sensor nodes, or a refinement of the known position to a more exact position by using triangulation, RF modulation, etc., as has been described above. In one example, the base nodes can include a node location module configured to determine the location of the sensor nodes after placement. The node location module can operate with the communications system to communicate between base nodes, sensor nodes, or both to refine the known location of the placed sensor nodes. In another aspect, the communications system can be used to determine a location of a worker in the field (using positional devices as described above). The system may also determine a location of the worker in the field with respect to a location of a placed sensor device. In another aspect, the system can determine a location of the sensor or the worker with respect to a desired location for placing the sensor device. Additionally, knowledge of the position of prior sensor nodes may be used in choosing the placement of future sensor nodes, in order to, for example, attain a more complete coverage.

Efficacy of some of the positional devices can be enhanced using a guidance module. Accordingly, the system can further include a guidance module. The guidance module can be used to guide the user to the sensor node placement locations. In one example, the base nodes can determine a current position of a passive sensor node or a worker, such as through triangulation, signal phase delay, etc. The guidance module can provide guidance to the user to guide the user from the current position to the desired or predetermined sensor placement location. For example, the guidance signals may comprise audio or visual signals. Other sensory signals may also be used. For example, tactile signals may be transmitted to a handheld device used by the worker.

Visual signals can be displayed or transmitted to the worker in a number of ways. For example, the base node can transmit a wireless guidance signal to an electronic device carried by the worker. The electronic device can then display the guidance signal to the worker in the form of arrows, text, symbols, etc. which may be useful in guiding the worker to the desired location. In another aspect, the base node may include a visual display or one or more visual indicators which may be visible by the worker in the field and provide guidance to the worker.

In other embodiments, the guidance module can be configured to transmit audio guidance signals to guide a worker to a desired sensor device location based on the comparison of the triangulated position and the desired sensor device location. The audio signals can be broadcast as guidance instructions by one or more speakers at the base node or some other location in the field in communication with the base node so that a worker in the field can hear the guidance instructions. In another aspect, the audio signals can be transmitted to a listening device 135 carried by the worker. The listening device can include a speaker by which the worker can hear the instructions. For example, the speaker may be part of headphones worn by the worker. In another example, the speaker may be part of a radio, walkie-talkie, Personal Digital Assistant (PDA), smart-phone, or any wired or wireless receiver.

Transmitted audio signals may comprise voice directions instructing the worker to move in a particular direction. The instructions may instruct the worker to move a specified distance in the particular direction. In another aspect, the voice directions may be provided through a text to speech module on the electronic device carried by the worker when the guidance signal is transmitted in text. In another aspect, the transmitted signals can be sent as coded signals, which may include one or more audible tones or a radio signal. For example, the audio signals may include a tone or click frequency. The audio signals may include varying frequencies of tones or series of tones which can be used to indicate an approximate distance from the desired sensor device location. The audio signal can include two or more different signals, such as a lateral guidance signal and an axial (e.g., height) guidance signal.

The system may include one or more sensor devices which are located in the sensor network or which are to be placed as part of the sensor network. A sensor device can be a sensor network node and may be arranged as part of an array of sensor devices. The sensor network can be a wired or a wireless sensor network. For convenience and simplicity, in many applications a wireless sensor network may be desirable over a wired network. The sensor devices can be configured to monitor conditions in the field. The monitored conditions can vary greatly depending upon the application and may include conditions such as those described above regarding potential uses of sensor networks. The sensor device can be configured to communicate with another sensor device and/or with one or more base nodes or other devices. In wireless sensor networks, the sensor devices may be battery-operated, solar-powered, etc. The sensor devices may be constructed to be able to withstand even harsh environmental conditions, including very low or very high temperatures or fluctuations in temperature, or various degrees of precipitation of various forms. The sensor devices can be constructed to withstand a minimal degree of applied force, such as a rock dropping onto the sensor device or a foot fall.

Installed sensor devices may form the sensor network. The sensor network can be configured to cope with node failures. In one aspect, the sensor network may comprise a wireless mesh network. The sensor network may be configured to adapt to the mobility of nodes (e.g., sensor devices), or to dynamically maintain a network topology. For example, the sensor network can resolve or work around communication failures, etc. The sensor nodes can be small computing devices, which have interfaces and computing components. The sensor nodes may include a processing unit with limited computational power and limited memory, sensors (including specific conditioning circuitry), a communication device (usually radio transceivers or alternatively optical), and a power source. In some aspects, the base nodes can be distinguished from the sensor nodes as having much more computational, energy and communication resources. One or more base nodes can act as a gateway between sensor nodes and a user or administrator.

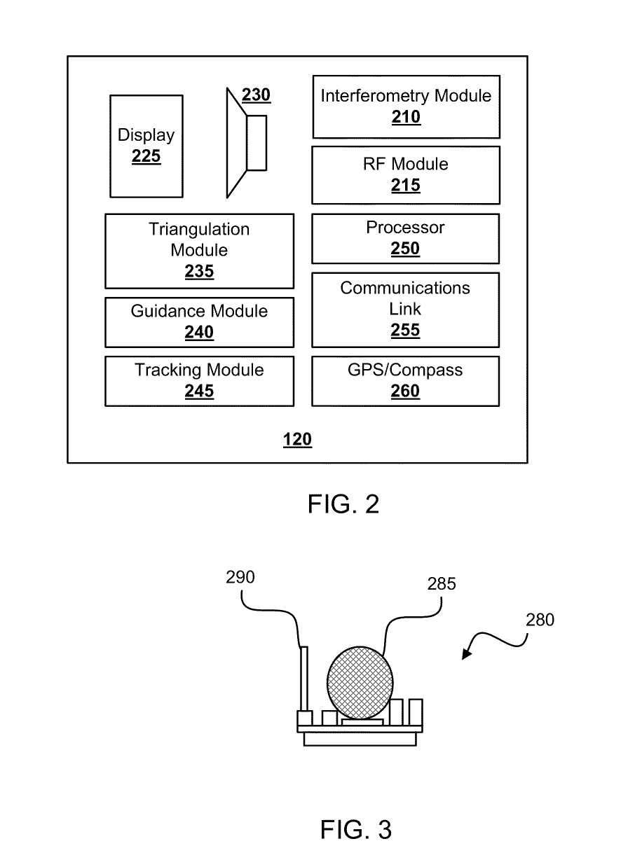

Referring to FIG. 2, a base node system is shown for accurately positioning sensor nodes in the sensor network. The base node system of FIG. 2 illustrates some of the features described above.

The base node system can include a triangulation module 235. Where triangulation can be performed using rotating optical beams and detectors, the triangulation module can be in communication with the rotating optical beams and detectors to be able to determine a rotational angle of the optical beam at the time a reflection or signal is detected. In some aspects, the communication may be the transmission of the position of the rotating optical beam and/or detector at the time of the detection. Also, for example, the system may be configured to monitor a rotation position of the rotating optical beam or detector. Though the rotating optical beam or the detector may not actually transmit rotation information to the triangulation module, the triangulation module may be said to be in communication with the rotating optical beam and/or the detector because of the monitoring of the rotation of the beam and/or detector.

The system may include components such as an interferometry module 210 or RF module 215 in addition to or in place of the triangulation module. The interferometry module and RF module can operate as described above in using interferometry to provide wave peaks marking sensor placement location or RF time or phase delay to determine distance. Some systems may be configured to provide sensor node location information through a plurality of mechanisms, such as triangulation, interferometry, etc. and may be adapted to selectively switch between the mechanisms. For example, one mechanism may be used for coarse positioning, such as an acoustic mechanism, while another mechanism is used for fine positioning, such as interferometry.

The base node system may be equipped with a GPS system 260. The GPS system can be a differential GPS system and can be used to determine a precise position of the base node. In one aspect, the base nodes can also communicate with one another to determine the location of the other base nodes. The base nodes may include a compass 260. The station can use the compass to determine the location of magnetic North. Vector angles in triangulation at the time of detection can be determined with respect to magnetic North. Additional angles and or vectors may be calculated from this determination to better facilitate triangulation.

For example, the sensor network may be placed over uneven terrain. Use of laser lines, RF signals, etc. can enable determination of a current sensor device location with respect to a placement location at a variety of different heights. In applications involving an uneven terrain, the base nodes may be placed at one or more of the highest locations in the field. This can allow the signals from the base node to reach a reflector at most or all locations within the field without obstruction by the landscape.

In accordance with certain configurations, one or more of the base node systems can include a processing module. The processing station can include a processor 250. In examples where the positional device is an electronic device, the processing module can be associated with the positional device. The processing module can also be in communication with sensor nodes. The processor can be used in processing the current positions and desired placement positions to provide information to the guidance module 240 in guiding a user to place the sensor nodes. The guidance module can also be used in connection with a visual display 225 or an audio speaker 230 to provide guidance to the worker.

A communications system was described previously. The communications system can include a communications link 255 in the base node system for communicating with one or more other base node systems. The communications link can facilitate electronic communication between processing modules. The communications link can be used to transmit information from one base node system to another. In one aspect, each base node system may compute a current sensor node location with respect to the desired placement location. One base node system may triangulate the position and communicate the result to another base node system. In another aspect, a single base node system may receive the information from another base node system and transmit guidance signals to a worker. In yet another aspect, different base node systems may be used to provide guidance to different workers. The communications link between the base nodes may be any suitable type of communications link. For example, the base nodes may communicate via a cable, wireless transmission, laser link, etc.

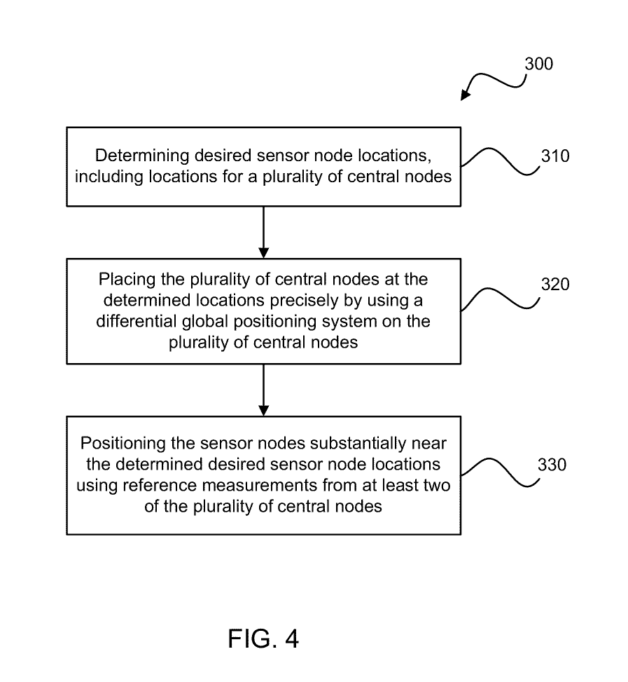

Referring to FIG. 3, an example side view of a sensor node device 280 with an attached reflector 285 is shown. The reflector can be used in triangulation as described above. The reflector can be permanently or removably attached to the sensor node device. In other examples described above, the sensor node device does not include a reflector and a reflector can be carried or worn by a worker. In yet other examples, a reflector is not used, but other positional devices are used to determine a location of the sensor node device. In some examples, the sensor node device is a passive device. Alternatively, the sensor node device may be an active device. The sensor node device can include an antenna 290 for transmission or receipt of signals to or from other sensor node devices or to or from one or more base nodes.

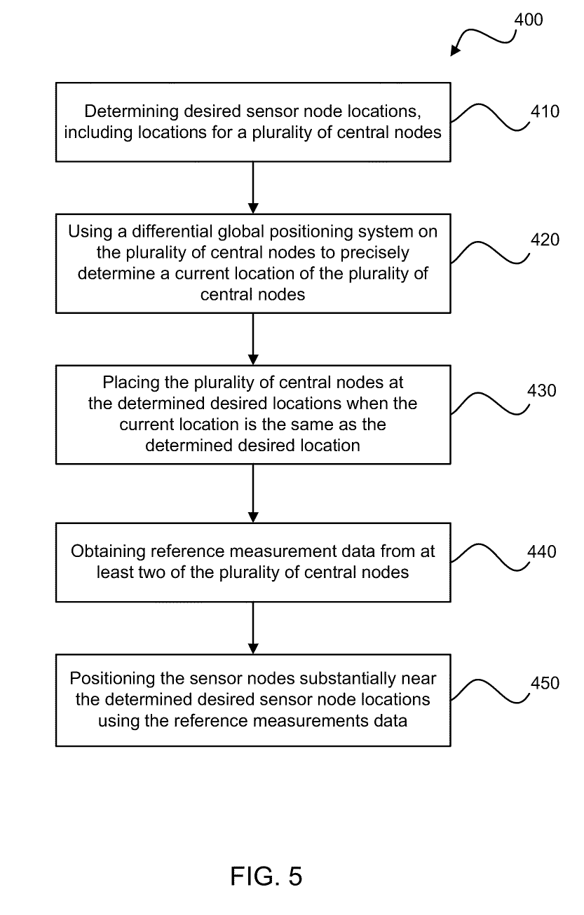

Referring to FIG. 4, a flow chart diagram of a method 300 is shown for positioning sensor nodes in a sensor network. The method can include determining 310 desired sensor node locations. Also locations for base nodes can be determined. While throughout this description the terms “sensor node” and “base node” are used to provide distinction, the base node may also comprise a sensor node. In other words, the base node may include the same functionality as a sensor node as well as additional functionality, such as differential GPS, etc.

The method can include placing 320 the base nodes at the determined locations precisely by using the differential GPS on the base nodes. The sensor nodes can be positioned 330 substantially near the determined desired sensor node locations using reference measurements from at least one of the base nodes. For example, sensors can be placed at fixed distances from one base node in a radial geometry. Circular areas surrounding the base node can even obtain angular coverage of sensors if combined with a compass. For example, a worker can start at the base node and use a compass to move at a definite angle, placing sensors at certain radial distances from the base node.

In one example, positioning the sensor nodes may further comprise transmitting a guidance signal from the base nodes to a user. The method may further include determining a current location of the sensor nodes with respect to the desired sensor node locations, and providing guidance signals to a user to guide the user from the current location to the desired sensor node locations. Alternatively, the method can include determining a current location of a user with respect to the desired sensor node locations and providing guidance signals to the user to guide the user from the current location to the desired sensor node locations.

The method can include transmitting a beacon signal from the base nodes to the sensor nodes. The signal can be received by one or more of the sensor nodes and a response can be transmitted from the sensor nodes back to the base nodes to facilitate guidance of a worker in placing the sensor node. The method may also include transmitting a beacon signal from a sensor node to the base nodes. The signal can be received at the base nodes and a guidance signal can be transmitted from the base nodes to the sensor node or to a worker carrying the sensor node. In yet another aspect, the method can include transmitting a beacon signal from the base nodes to a sensor node where the signal is received. A guidance signal can then be provided to a user to guide the user to one of the desired sensor node locations based on the signal received at the sensor node. In other examples, transmission and receipt of signals can occur through the base nodes and an electronic handheld device carried by the worker rather than through the sensor nodes.

As has been described above, the positioning step of the method can be performed using a variety of positioning means or devices. For example, positioning can be performed using reference measurements from at least one of the base nodes by aligning a row of sensor nodes with a cable extending between the base nodes. For example, positioning can be performed using a cable having a predetermined length and extending from at least one of a first individual sensor node and an individual base node to position a second sensor node relative to the first individual sensor node or the individual base node.

Alternatively, positioning the sensor nodes substantially near the determined desired sensor node locations using reference measurements from at least one of the base nodes may comprise using timing of RF pulses to determine a distance of a sensor node from the two base nodes. Positioning can also be performed using interferometry to cause an electromagnetic signal transmitted from the base nodes to peak at the determined desired sensor node locations.

In one example, the method can further include transmitting a placement signal to a base node when a sensor node is positioned. The placement signal can be transmitted from the placed sensor node or from another device, such as the handheld electronic device carried by the worker, as described above. For example, the sensor node or the handheld electronic device may comprise a button or an interface through which the worker can indicate placement by pressing the button or manipulating the interface. The placement signal can indicate to the base node that the sensor node has been placed in the desired predetermined location. If refinement of the location is to be performed, the refinement can be performed after the placement signal is received.

In accordance with additional embodiments, the method can include tracking a plurality of workers or sensor nodes substantially simultaneously. For example, multiple workers may be in the field, each worker placing sensors in the sensor network. The system can include a tracking module 245 (see FIG. 2) configured to track the location of each of the workers to distinguish between the workers. Using triangulation as an example, the tracking module can compare a position of a reflector at a first time with a position of the reflector at a second time. The tracking module can determine the likelihood that the reflector detected at the first and second times are the same. For example, if the system can compare the distance between the positions of the reflectors at the first and second time. If the distance between the two positions is greater than what may be expected or greater than what may be possible for a worker on foot to cover in the time between the first and second time, then the tracking module may determine that the two detections belong to two different reflectors. Likewise, the system can be configured to account for other means of transportation, such as ATV, truck, etc. which may cover greater distances in shorter amounts of time. In some embodiments, the tracking module can be configured to monitor a direction of movement of the reflector. If the detector detects a reflection which is inconsistent with the direction of movement of the reflector, the system can monitor and determine whether that detection is a redirection of the direction of movement of the first reflector or whether the detection is a second reflector.

The method and system can be configured to distinguish among sensors or workers. For example, again using triangulation as an example, reflectors on different sensor devices or worn by different workers may be formed using materials that can scatter light inelastically (e.g. Raman scattering). The laser light scatter by these devices will suffer a slight change in the wavelength and each device will be identified by the wavelength shift it imparts. The different inelastic wavelength shifts that the reflectors impart result in a wavelength of light reflected from one reflector being different than a wavelength of light reflected from a different reflector. Thus, if a first wavelength of reflected light is detected, the system can determine that the reflector belongs to a first worker, and if a second wavelength of reflected light is detected, the system can determine that the reflector belongs to a second worker.

The tracking module can thus be configured to identify and track multiple reflectors associated with multiple workers and/or sensors substantially simultaneously using a continuity of reflector position and/or the difference in wavelength of reflected laser beams from different reflectors. The guidance module can then transmit a plurality of different guidance signals to guide a plurality of workers to different desired sensor device locations. The guidance signals can be transmitted at particular frequencies, or to specific devices so as to provide guidance signals relevant only to a particular worker to that worker. In other embodiments, the guidance signals can be transmitted with worker identifiers to multiple workers and the workers can distinguish among the signals using the identifiers.

Referring to FIG. 5, a flow diagram of a method 400 is shown for positioning sensor nodes in a sensor network. The method can include determining 410 desired sensor node locations, including locations for a plurality of base nodes. A differential global positioning system on the plurality of base nodes can be used 420 to precisely determine a current location of the plurality of base nodes. The plurality of base nodes can be positioned 430 at the determined desired locations when the current location is the same as the determined desired location. Reference measurement data can be obtained 440 from at least one of the plurality of base nodes. The sensor nodes can then be positioned 450 substantially near the determined desired sensor node locations using the reference measurements data.

The systems and methods herein can be used for very accurate measurement of the locations of the sensor nodes during or after placement. For example, using the systems and methods can lead to accuracy of better than 10 cm in a 100×100 m field or even accuracy of up to 1/10^{th} cm or better in a 100×100 m field. This technology can provide a faster and less expensive means for setting up a sensor network than have been used in previous systems. Greater precision can be achieved than through previous methods and workers need not perform a survey, plant flags, use cables, etc. for determining sensor node locations. Also, as described above, the sensor node locations according to the present location, though shown as a grid in FIG. 1 can be laid out in any desired pattern and need not form a regular or grid pattern.

The sensor networks described herein can be used in many applications including, but not limited to: area monitoring, environmental monitoring, industrial monitoring, water or wastewater monitoring, landfill ground well level monitoring, flare stack monitoring, water tower level monitoring, vehicle detection, agriculture, windrow composting, greenhouse monitoring, exploration for oil or water, etc.

The various engines, tools, or modules discussed herein may be, for example, software, firmware, commands, data files, programs, code, instructions, or the like, and may also include suitable mechanisms.

Some of the functional units described in this specification have been labeled as modules, in order to more particularly emphasize their implementation independence. For example, a module may be implemented as a hardware circuit comprising custom VLSI circuits or gate arrays, off-the-shelf semiconductors such as logic chips, transistors, or other discrete components. A module may also be implemented in programmable hardware devices such as field programmable gate arrays, programmable array logic, programmable logic devices or the like.

Modules may also be implemented in software for execution by various types of processors. An identified module of executable code may, for instance, comprise one or more blocks of computer instructions, which may be organized as an object, procedure, or function. Nevertheless, the executables of an identified module need not be physically located together, but may comprise disparate instructions stored in different locations which comprise the module and achieve the stated purpose for the module when joined logically together. Indeed, a module of executable code may be a single instruction, or many instructions, and may even be distributed over several different code segments, among different programs, and across several memory devices. Similarly, operational data may be identified and illustrated herein within modules, and may be embodied in any suitable form and organized within any suitable type of data structure. The operational data may be collected as a single data set, or may be distributed over different locations including over different storage devices. The modules may be passive or active, including agents operable to perform desired functions. Furthermore, the described features, structures, or characteristics may be combined in any suitable manner in one or more embodiments. In the preceding description, numerous specific details were provided, such as examples of various configurations to provide a thorough understanding of embodiments of the described technology. One skilled in the relevant art will recognize, however, that the technology can be practiced without one or more of the specific details, or with other methods, components, devices, technological improvements, etc. In other instances, well-known structures or operations are not shown or described in detail to avoid obscuring aspects of the technology.

While the forgoing examples are illustrative of the principles of the present invention in one or more particular applications, it will be apparent to those of ordinary skill in the art that numerous modifications in form, usage, details, and means of implementation can be made without the exercise of inventive faculty, and without departing from the principles and concepts of the invention. Accordingly, it is not intended that the invention be limited, except as by the claims set forth below.

1. A system for positioning sensor nodes in a sensor network, comprising:
a plurality of base nodes comprising a differential global positioning system configured to determine a precise location of the plurality of base nodes;
a plurality of sensor nodes configured to be placed in locations with respect to the plurality of base nodes using measurement data from at least one of the plurality of base nodes;
a positional device configured to provide the position measurement data relative to the at least one of the plurality of base nodes to a user for use in placing the plurality of sensor nodes; and
a communications system configured to enable electronic communication between the plurality of base nodes and the plurality of sensor nodes.

2. A system in accordance with claim 1, further comprising a guidance module configured to guide the user to the sensor node placement locations.

3. A system in accordance with claim 2, wherein the guidance module comprises an audio signal transmitted to the user.

4. A system in accordance with claim 3, wherein the audio signal comprises varying frequencies of tones or series of tones to indicate an approximate distance from the sensor node placement location.

5. A system in accordance with claim 1, wherein the locations in which the plurality of sensor nodes are placed are predetermined locations.

6. A system in accordance with claim 1, further comprising a triangulation module configured to triangulate a position of the user with respect to at least two of the plurality of base nodes.

7. A system in accordance with claim 1, further comprising a node location module configured to determine the location of the plurality of sensor nodes after placement.

8. A method for positioning sensor nodes in a sensor network, comprising:
determining desired sensor node locations, including locations for a plurality of base nodes;
placing the plurality of base nodes at the determined locations precisely by using a differential global positioning system on the plurality of base nodes; and
positioning the sensor nodes substantially near the determined desired sensor node locations using reference measurements from at least one of the plurality of base nodes.

9. A method in accordance with claim 8, wherein positioning further comprises transmitting a guidance signal from at least one of the plurality of base nodes to a user.

10. A method in accordance with claim 8, further comprising:
determining a current location of at least one of the sensor nodes with respect to at least one of the desired sensor node locations; and
providing guidance signals to a user to guide the user from the current location to the at least one of the desired sensor node locations.

11. A method in accordance with claim 8, further comprising:
determining a current location of a user with respect to at least one of the desired sensor node locations; and
providing guidance signals to the user to guide the user from the current location to the at least one of the desired sensor node locations.

12. A method in accordance with claim 8, further comprising:
transmitting a beacon signal from the at least two of the plurality of base nodes to at least one of the sensor nodes;
receiving the signal at the at least one of the sensor nodes; and
transmitting a response from the at least one of the sensor nodes back to the at least one of the plurality of base nodes.

13. A method in accordance with claim 8, further comprising:
transmitting a beacon signal from at least one of the sensor nodes to the at least one of the plurality of base nodes;
receiving the signal at the at least one of the plurality of base nodes; and
transmitting a guidance signal from at least one of the at least one of the plurality of base nodes to the at least one of the sensor nodes.

14. A method in accordance with claim 8, further comprising:
transmitting a beacon signal from the at least one of the plurality of base nodes to at least one of the sensor nodes;
receiving the signal at the at least one of the sensor nodes; and
providing a guidance signal to a user to guide the user to at least one of the desired sensor node locations based on the signal received at the at least one of the sensor nodes.

15. A method in accordance with claim 8, wherein positioning further comprises at least one of:
using reference measurements from the at least two of the plurality of base nodes by aligning a row of sensor nodes with a cable extending between the at least one of the plurality of base nodes; and
using a cable having a predetermined length and extending from at least one of a first individual sensor node and an individual base node to position a second sensor node relative to the first individual sensor node or the individual base node.

16. A method in accordance with claim 8, wherein positioning the sensor nodes substantially near the determined desired sensor node locations using reference measurements from at least one of the plurality of base nodes comprises at least one of:
using timing of RF pulses to determine a distance of at least one of the sensor nodes from the at least one of the plurality of base nodes; and
using interferometry to cause an electromagnetic signal transmitted from the at least one of the plurality of base nodes to peak at the determined desired sensor node locations.

17. A method in accordance with claim 8, further comprising transmitting a placement signal to at least one of the plurality of base nodes when at least one of the sensor nodes is positioned.

18. A method in accordance with claim 17, further comprising determining a position of the positioned at least one of the sensor nodes relative to the at least one of the plurality of base nodes.

19. A method for positioning sensor nodes in a sensor network, comprising:
determining desired sensor node locations, including locations for a plurality of base nodes;
using a differential global positioning system on the plurality of base nodes to precisely determine a current location of the plurality of base nodes;
placing the plurality of base nodes at the determined desired locations when the current location is the same as the determined desired location;
obtaining reference measurement data from at least one of the plurality of base nodes; and
positioning the sensor nodes substantially near the determined desired sensor node locations using the reference measurements data.

20. A method in accordance with claim 19, wherein positioning further comprises transmitting a guidance signal from the at least one of the plurality of base nodes to a user.
